(19) United States
(12) Patent Application Publication
(10) Pub. No.: US 2008/0310399 A1
(43) Pub. Date: Dec. 18, 2008

(54) Methods and systems for connecting phones to internet users

(75) Inventors: Rajesh Narayanan, San Jose, CA (US); Ashish Patel, Sunnyvale, CA (US)

Correspondence Address: BUCHANAN, INGERSOLL & ROONEY PC, POST OFFICE BOX 1404, ALEXANDRIA, VA, 22313-1404, US

(73) Assignee: IMVocal, Inc., Santa Clara, CA (US)

(21) Appl. No.: 11/818,076

(22) Filed: Jun. 12, 2007

(51) Int. Cl. H04L 12/66

(52) U.S. Cl. 370/352

(57) ABSTRACT

Methods and systems for connecting a phone to a client via a network by using an electronic notification system, which may include a third-party internet electronic messenger service, such as, Yahoo messenger™, Google Talk™, MSN messenger™ software, or email systems. The system includes a server that is connected to the network and receives a call from the phone and that sends a notification of the incoming call to the client via the electronic notification system like internet messenger service of choice of the client/receiver. The user of the client, receiver, launches an internet phone on the client in response to the notification by clicking on the called-context link. Then, the server connects the phone to the client via the internet phone whereby providing a communication between the receiver and a user of the phone, caller.

### BACKGROUND

There have been many approaches for making communications over the Internet using the so-called Voice-over-Internet-Protocol (VoIP). VoIP refers to the routing of voice communications over the Internet or through any other IP-based network. VoIP technology works by converting analog voice into digital data packets and sending the packets over the Internet to another communication network.

Typically, the users subscribe to a VoIP service that allows them to access a server that can make VoIP long distance phone calls. Since the digitized packets of VoIP calls are not sent via the circuit-switched inter-exchange carrier (IXC), such as AT&T, Verizon, and Sprint systems, the user is billed for long distance calls at much lower rates. However, for an incoming call originated from PSTN/mobile to the Internet, one or both parties using conventional VoIP services still pay depending upon minute plan and termination charges, which is one of the difficulties of the conventional VoIP services.

Another difficulty of the conventional VoIP services is that each user is exclusively signed-up for an online communication service (or, shortly, online service), such as, AIM®, Yahoo and MSN Instant Messengers™ software, to receive incoming calls through the Internet. The conventional VoIP systems do not allow a subscriber to receive calls irrespective of the type of online service. For instance, a subscriber signed-up for one type of online service, say AIM, cannot be reached by the conventional VoIP systems if the subscriber is using a computer installed with another type of online service, say MSN Instant Messenger. As such, there is a need for systems and methods that can allow phone users (callers) to access internet users (receivers) at no charge and allow the internet users to be reached without being limited by the type of online service.

### SUMMARY

According to one embodiment, a method of connecting a phone to a client via a network includes steps of: receiving a call from the phone; sending a notification of the call to the client; causing a user of the client, receiver, to launch an internet phone on the client in response to the notification; and connecting the phone to the client via the internet phone whereby providing a communication between the receiver and a user of the phone, caller.

According to another embodiment, a system for connecting a phone to a client via a network includes a server connected to the network. The server includes: means for receiving a call from the phone; means for sending a notification of the call to the client; means for causing a user of the client, receiver, to launch an internet phone on the client in response to the notification thereby to accept the call; and means for connecting the phone to the client via the internet phone whereby providing a communication between the receiver and a user of the phone, caller.

### BRIEF DESCRIPTION OF THE DRAWINGS

FIG. 1 shows a schematic diagram of a system environment in accordance with one embodiment.

FIGS. 2A-2B show a flow chart illustrating an exemplary process for connecting a phone to an internet user in accordance with another embodiment of the present invention.

FIG. 3 shows a flow chart illustrating an exemplary process for connecting a phone to an internet user in accordance with another embodiment of the present invention.

FIG. 4 shows a flow chart illustrating an exemplary process for connecting a phone to an internet user in accordance with another embodiment of the present invention.

### DETAILED DESCRIPTION OF THE PREFERRED EMBODIMENTS

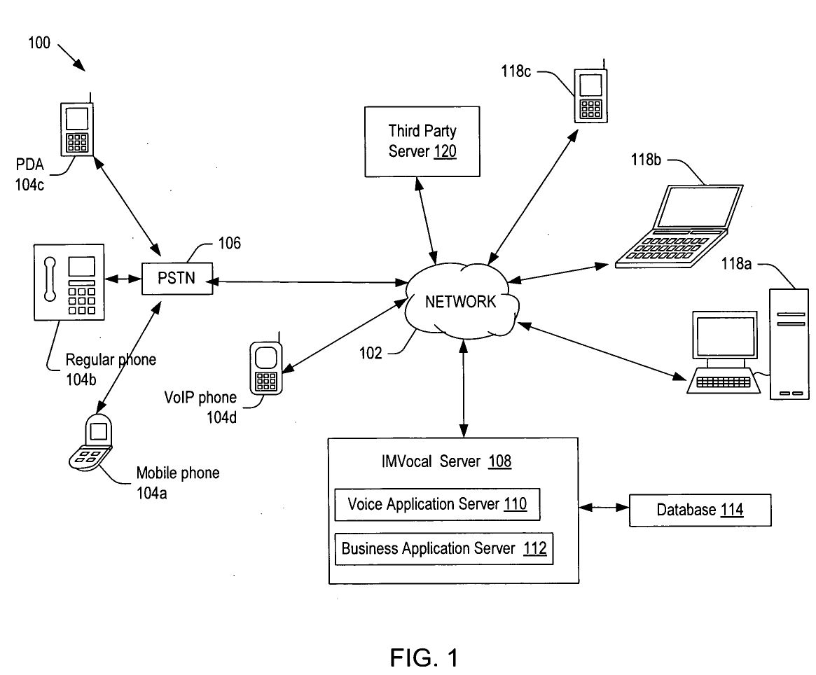

Referring now to FIG. 1, there is shown a schematic diagram of a system 100 in accordance with one embodiment. As depicted, the system 100 includes caller devices 104a-104d that can communicate voice messages with other audio (and video) communication devices. The caller devices may include a mobile phone 104a, a regular or land-line phone 104b, a personal digital assistance phone (PDA) 104c, which can be coupled to a public switched telephone network (PSTN) 106 by various connection mechanisms. The caller devices may also include a VoIP enabled phone (or, shortly, VoIP phone) 104d coupled to the network 102, such as the Internet. Hereinafter, for simplicity, the caller devices 104a-104d are collectively referred to as phone, even though each of the caller devices 104a-104d may also include a display window for displaying and/or communicating video data with other devices. Also, for the purpose of illustration, the network 102 is assumed to be the Internet. However, it should be apparent to those of ordinary skill that the network 102 can be of other suitable type, such as LAN or WAN.

Each of the phones 104a-104d can be coupled to the network 102 via a suitable connection mechanism/system. For instance, the mobile phone 104a may communicate wireless signals with a wireless carrier (not shown in FIG. 1) that is in turn connected to the PSTN 106. For another instance, the VoIP phone 104d may be connected to the PSTN 106 via VoIP/PSTN gateway (not shown in FIG. 1). It is noted that the phones 104a-104d are exemplary audio communication devices connected to the network 102. Thus, it should be apparent to those of ordinary skill that other types of phones can be practiced in the system 100 and each phone can be connected to the network via any suitable connection mechanism. It should be also apparent to ordinary skill that other suitable number of phones can be connected to the network 102 without deviating from the spirit and scope of the present teachings.

The phones 104a-104d can be connected to clients 118a-118c via the network 102 that may be operated by internet users or receivers. Each client may include components for audio communication, such as speaker and microphone, and a display window for displaying visual images. Also, each client is installed with at least one online service, such as AIM®, Yahoo Instant messenger™ software, MSN Instant Messenger™ software, GoogleTalk®, Lycos Globe7™ software, Jingle Networks™ software and Naver™ software, and a web browser for communication.

The clients may include, but are not limited to, a PC 118a, a laptop computer 118b, and a PDA device 118c. As in the case of phones 104a-104d, other types of electronic devices may be used as clients. For instance, a server (not shown in FIG. 1) may be connected to the network 102 and a plurality of clients can be connected to the network 102 via the server. It is to be understood that other suitable number of clients can be connected to the network 102 without deviating from the spirit and scope of the present teachings. It is also to be understood that each client can be connected to the network 102 by any suitable connection mechanism.

The IMVocal server 108 may be connected to the network 102 and a database 114. In one exemplary embodiment, the server 108 and database 114 may form an integral body. In another exemplary embodiment, the server 108 may be installed in several mirror sites that are remotely located from each other and connected to the network 102. The IMVocal server 108 may be connected to a third body server 120 of an online advertising marketplace, such as AdBrite and FederatedMedia, via the network 102.

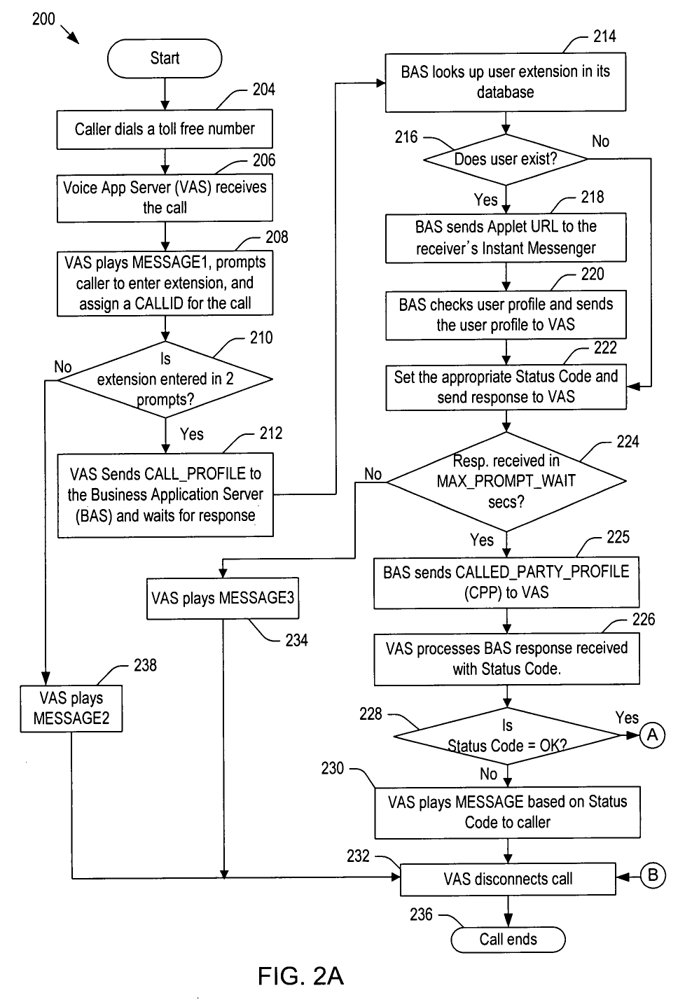

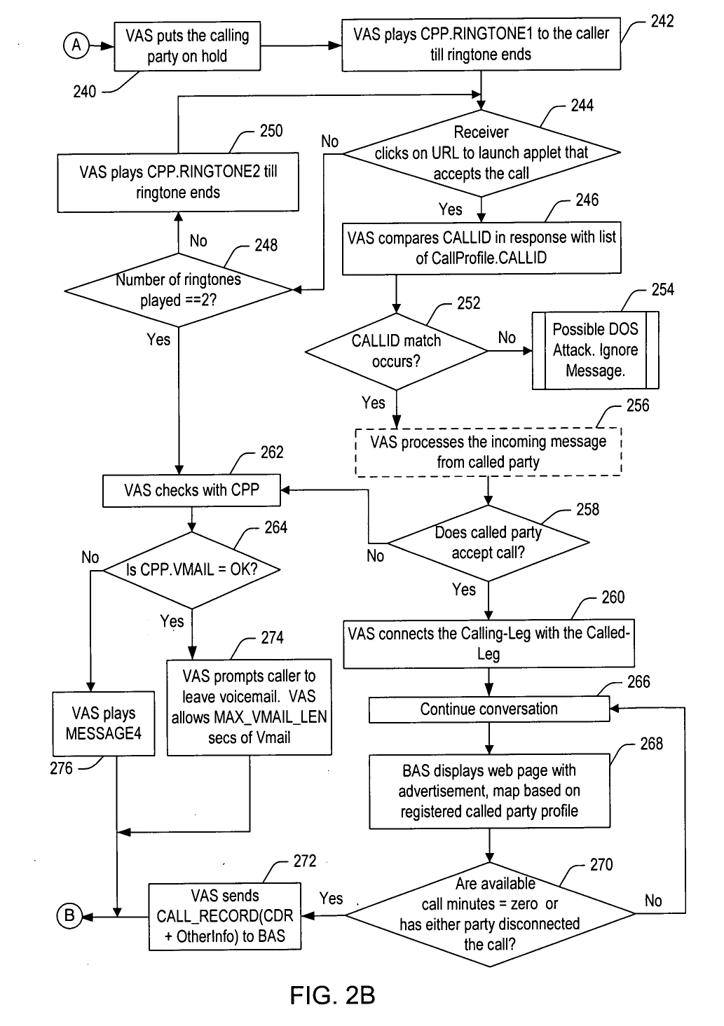

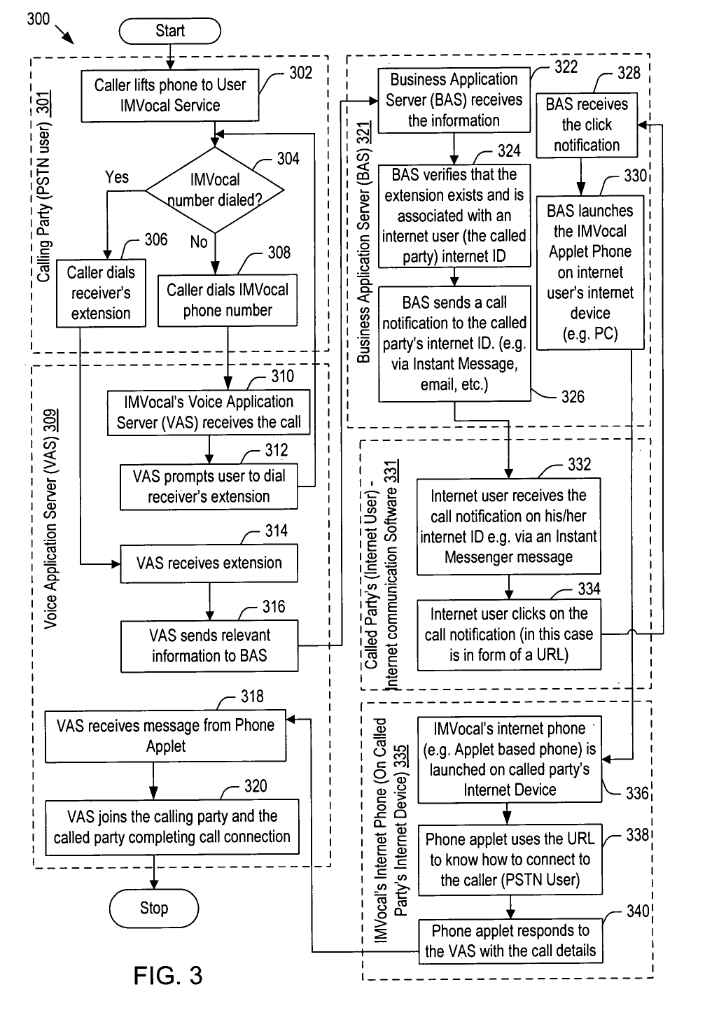

The IMVocal server 108 may include one or more servers, such as voice application server (VAS) 110 and business application server (BAS) 112. The operation and functions of these servers are detailed in conjunction with FIGS. 2A-3. The IMVocal server 108 may include other modules and servers therein. For instance, the IMVocal server 108 may include a database module for storing/retrieving data from the database 114. For simplicity, the detailed description of modules and other servers in the IMVocal server 108 is not given in the present document since their operational and structural mechanisms should be apparent to those of ordinary skill.

The IMVocal server 108 may connect a phone, say 104a, to a client, say 118a. FIGS. 2A-2B show a flow chart 200 illustrating an exemplary process for connecting the phone 104a to the client 118a in accordance with another embodiment of the present invention. It will be appreciated by those of the ordinary skill that the illustrated process may be modified in a variety of ways without departing from the spirit and scope of the present teachings. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

The caller, i.e., the user of the phone 104a, may dial a phone number of the IMVocal server 108 to connect to the IMVocal server in a state 204. In one exemplary embodiment, the phone number is a toll free number. The voice application server (VAS) 110 may receive the incoming call and play MESSAGE1 to the caller in states 206 and 208. MESSAGE1 may include an advertisement and a prompt to enter the receiver's extension number (or, shortly extension). The advertisement, such as “this call is sponsored by xxxx,” may allow the IMVocal server 108 to generate revenue and the caller to earn credit for the time to communicate with clients via the IMVocal server. In one exemplary embodiment, the earned credit may be stored in the database 114. In the state 208, the VAS 110 may also assign a unique identifier, referred to as CALLID, for the incoming call from the phone 104a. In one exemplary embodiment, the CALLID may be a numeric or alphanumeric characters, strings, or the like. This unique identifier may be local to the VAS and have temporary significance for the VAS as long as the call is in progress.

The extension may be a disposable phone number (or, alphanumeric string) assigned to the receiver by the IMVocal server 108. The extension number (or, shortly extension) may expire after the lapse of a preset period of time from issuance thereof. To get a new extension, the receiver may contact the IMVocal server in advance by email, phone, or the like. Upon receipt of the new extension, the receiver may inform the caller of the new extension in advance so that the caller can enter the receiver's extension in response to the MESSAGE1. Also, the IMVocal server 108 may associate the new extension number with internet ID of the receiver. Then, the process may proceed to a decision block 210.

In the block 210, a determination may be made as to whether the extension is entered by the caller. In one exemplary embodiment, the call may be allowed to enter the extension twice. If the caller fails to enter the extension correctly, the VAS 110 may play MESSAGE 2, such as “the extension is invalid,” to the caller in a state 238 and subsequently disconnect the call in a state 232. Upon positive answer to the decision block 210, the VAS 110 may send CALL_PROFILE to the business application server (BAS) 112 and wait for a response from the BAS in a state 212. The CALL_PROFILE may include, for instance, caller ID and the extension. Then, the process may proceed to a state 214.

In the state 214, the BAS 112 may use the extension in CALL_PROFILE received from the VAS 110 and look up the extension in the database 114. Next, a determination as to whether or not a receiver (or, clients of the receiver) corresponding to the extension exists in the database may be made in a decision block 216. Upon negative answer to the decision block 216, the process may proceed to a state 222. Otherwise, the BAS112 may send a notification in the form of an applet having an Uniform Resource Locator (URL) address (or, shortly, applet URL) to the client's online service in a state 218. In one exemplary embodiment, the URL may be represented as a string. In another exemplary embodiment, the applet may be in the form of a button or icon that when pressed can open the IMVocal's applet. In yet another exemplary embodiment, the BAS 112 may send a notification to the receiver by email if the client includes an email service.

The client 118a may be installed with an online service, such as AIM®, Yahoo Instant messenger™ software, MSN Instant Messenger™ software, GoogleTalk®, Lycos Globe7™ software, Jingle Networks™ software and Naver™ software, which includes an IMVocal bot. In one exemplary embodiment, the IMVocal bot may be included in the contact list of the online service. If the client's online service is running when the applet URL is sent to the client 118a in the state 218, the IMVocal bot in the client's online service may respond to display an URL address as a message in the online service window. The URL address corresponds to a web address of the IMVocal server 108.

The IMVocal bot can be added to any type of online service by the receiver. Thus, the receiver or called party can be reached via anyone of the many online services with a single identifier, i.e., the extension number, without the need for sharing all his/her personas. The IMVocal server 108 may send the applet URL to at least one of the clients associated with the extension number in the state 218.

The information of the client(s) to be used by the receiver may be provided to the IMVocal server 108 by the receiver in advance so that the IMVocal server can associate the client(s) with the extension number. In one exemplary embodiment, the information may include the type default URL address of the client that is most frequently used by the receiver. In another exemplary embodiment, the information may include multiple URL addresses of several identifiers of different online messenger services such as, but are not limited to, Gtalk™, MSN™, Yahoo™ softwares, clients so that the BAS server 112 can send a URL of the applet that receives the incoming call URL applet to the clients, either simultaneously or one by one, thereby to search for the client that the receiver is currently using. The multiple clients may be prioritized and stored in the database 114.

In a state 220, the BAS 112 may check a user profile and send the user profile to the VAS 110. The user profile may include information, such as the time available to the caller. Subsequently, in a state 222, the BAS may set an appropriate Status Code regarding the status of the client 118a and send a response along with the Status Code to the VAS 110, wherein the response may include USER_NOT_FOUND, USER_NOT_AVAILABLE, USER_NOT_LOGGED_IN, USER_VOICEMAIL, SUCCESS, FAILURE, or the like. Next, in a decision block 224, the BAS 112 may check if the receiver responds to the applet URL in MAX_PROMPT_WAIT seconds, i.e., it is determined whether or not the receiver responds within MAX_PROMPT_WAIT seconds. In one exemplary embodiment, the receiver may respond by clicking the URL address displayed on the online service window, such as, but are not limited to, Yahoo IM Window™, MSN window™ softwares, so that a new web page that contains the IMVocal service instance for that call along with other information from of the IMVocal server 108 may be displayed on the client 118a. In another exemplary embodiment, the receiver may respond by opening a new web page and enter the URL address of the IMVocal server 108 thereby to connect to the IMVocal server 108. Upon negative answer to the decision block 224, the VAS 110 may play MESSAGE3 to the caller to inform that the receiver cannot be reached. If the answer to the decision block 224 is positive, the process may proceed to a state 225.

In the state 225, the BAS 112 sends the CALLED_PARTY_PROFILE (CPP) to the VAS 110, wherein the CPP includes, but are not limited to, information such as the number of minutes left for the call and which ringback tone is to be played on the caller's side. Subsequently, in a state 226, the VAS 110 may process the response and Status Code received from the BAS 112 in the state 222. Next, in a decision block 228, the VAS may check if the Status Code is equal to OK, meaning the client 118a is online and ready for communication and/or the receiver is willing to accept the incoming call. It is noted that the comparison in the state 228 is of exemplary nature and that the comparison may be made against other suitable strings or values, such as USER_ONLINE, SUCCESS, or the like.

Upon positive answer to the decision block 228, the process may proceed to a state 240 (FIG. 2B). Otherwise, the process may proceed to a state 230. In the state 230, the VAS 110 may play MESSAGE, such as “the party you are trying to reach is unavailable,” to the caller based on the Status Code and, subsequently disconnect the call in the state 232. Then, the call ends in a state 236.

In the state 240, the VAS 110 may put the caller on hold. Then, in a state 242, the VAS may play CPP.RINGTONE1 to the caller until a first ringtone ends. In one exemplary embodiment, the CPP.RINGTONE1 may be an audio message. In another exemplary embodiment, the CPP.RINGTONE1 may be a video message in case the calling phone is capable of receiving it, wherein the video message may also include audio messages. It is noted that other type of message, such as commercial advertisement, may be played instead of the ringtone. Next, the process may proceed to a decision block 244. In the block 244, the VAS 110 may determine whether the receiver responds to the applet URL displayed on the online service window to launch a new web page. In one exemplary embodiment, the new web page may include a phone applet for accepting the incoming call and other various features, such as advertisement banners of sponsoring entities. The web page may also include an icon coupled to the phone applet, making the receiver perceive the feeling as if the receiver is using a regular phone. The phone applet may also display information related to the call, such as caller ID and time available for the call, wherein the available time is associated with the credit earned by the caller.

Upon negative answer to the block 244, the process may proceed to a decision block 248. In the decision block, a determination may be made as to whether the ringtone has played twice. (It should be apparent to those of ordinary skill that the ringtone may be played more than twice to proceed further steps from a state 262.) Upon negative answer to the block 248, the process may proceed to a state 250. In the state 250, the VAS may play CPP.RINGTONE2, which is similar to CPP.RINGTONE1, until a second ringtone ends. Then, the process may proceed to the state 244. Upon positive answer to the block 248, the process may proceed to the state 262. If the answer to the block 244 is positive, the process may proceed to a state 246. It is noted that the notion of RINGONE1 and RINGTONE2 is just to show that the CPP may contain any suitable number of profile elements of the user and include more than two ringtones.

In the state 246, the VAS 110 may compare the CALLID assigned to the call in the state 208 with the list of CallProfile.CALLID stored in the database 114. Typically, there can be a large number of incoming calls received by the IMVocal server 108. Thus, if the CALLID does not match anyone in the CallProfile.CALLID list, it is likely that the incoming call may be from a hacker or a denial-of-service (DOS) attacker. It may also be possible that the internet user may receive the link after a while and click on it thinking the call is recent. However, as the CALLID may be of temporary nature and expire if the call is not in process, the click would not result any connection.

Next, the process may proceed to a decision block 252 to determine whether the CALLID matches one of the CallProfile.CALLID, i.e., the caller is a DOS attacker or the call has expired and no longer valid. Upon negative answer to the block 252, the process may proceed to a state 254 to ignore (or, equivalently, end) the caller's call as a possible DOS attack. Otherwise, the process may proceed to an optional state 256.

In the state 256, the VAS 110 may process the incoming message from the caller. Then, the VAS 110 may determine whether or not the receiver or called party accepts the call in a decision block 258. Upon negative answer to the block 258, the process proceeds to the state 262. In the state 262, the VAS 110 may check the CPP received from the BAS 112 in the state 255. Then, in a state 264, the VAS may determine if CPP.VMAIL is OK, i.e., the called party's voice mail account is ready to accept a voice mail and/or the called party has subscribed to voicemail feature as part of the service offering.

Upon negative answer to the block 264, the VAS 110 may play MESSAGE4, such as “the receiver does not have voice mail setup” or “the receiver's vmail box is full.” Then, the process may proceed to the state 232 (FIG. 2A) to disconnect the call.

If the answer to the state 264 is positive, the process may proceed to a state 274. In the state 274, the VAS 110 may prompt the caller to leave a voice mail and allow the caller to record a voice mail during the MAX_VMAIL_LEN seconds. Then, the process may proceed to the state 232.

Upon positive answer to the block 258, i.e., the receiver accepts the call, the process may proceed to a state 260. In the state 260, the VAS 110 may connect the calling-leg to the called-leg, i.e., the caller may communicate with the receiver via the web page that is opened by clicking the applet URL, is displayed on the client, and includes a phone applet. The conversation may continue in a state 266. In a state 268, the BAS 112 may display advertisement(s) on the web page, wherein the advertisements are mapped based on the profile of the client 118a, such as gender, age, or the like. Then, the process may proceed to a decision block 270.

In the block 270, the process may determine whether the available call minutes are zero or either part has disconnected the call. Upon negative answer to the decision block 270, the process may proceed to the state 266. Otherwise, the process may proceed to a state 272. In the state 272, the VAS 110 may send CALL_DETAIL_RECORD (CDR) and other information to the BAS 112. The CALL_DETAIL_RECORD may include information related to the call, such as time of the call, duration of the call, or the like. It is noted that the caller may earn credits for call minutes by listening to the commercial messages in the states 208, 242, and 250. The earned time may be added to the MAX_CALL_DURATION. In one exemplary embodiment, each call may be given a ‘fixed-time’ which gets added to the MAX_CALL_DURATION. If the parties hang-up in less than the ‘fixed-time’, the difference between the actual-time talked and the fixed time may be added to the MAX_CALL_DURATION. In another exemplary embodiment, if the earned time (earned by, such as, listening to commercials), is longer than the duration of the call, the leftover time may be rolled over for the next call, wherein the CALL_RECORD may include the leftover time information. Then, the process may proceed to the state 232 to disconnect the call.

FIG. 3 shows a flow chart 300 illustrating an exemplary process for connecting a phone (say 104a) to an internet user of a client (say 118a) in accordance with another embodiment of the present invention. As depicted, the flow chart 300 is divided into five blocks 301, 309, 321, 331, and 335, each block including steps taken by one of the five major actors; caller or calling party, voice application server (VAS) 110, business application server (BAS) 112, internet communication software (such as Instant Messenger) of the called party or internet user, and IMVocal internet phone (or phone applet) that may be run after being launched by the explicit clicking on the URL on the called party's internet device 118a. Each step of the flow chart 300 may correspond to one or more states in FIGS. 2A-2B, which should be apparent to those of ordinary skill in the art.

In a state 302, a caller may lift a phone to call User IMVocal Service (or, equivalently, IMVocal server). In one exemplary embodiment, the caller or calling party may use a PSTN phone a VoIP based phone. Then, the VAS 110 may check whether the caller dialed the IMVocal number in a state 304. In one exemplary embodiment, the IMVocal number may be a toll free number. Upon positive answer to the state 304, the caller may be prompted to enter the extension of the receiver in a state 306 and subsequently the process may proceed to a state 314. For the purpose of illustration, the client 118a is assumed to be associated with the receiver's extension number. If the answer to the state 304 is negative, the process may proceed to a state 308.

In the state 308, the caller may dial the IMVocal number. Next, in a state 310, the VAS 110 may receive the call. Then, the VAS may prompt the caller to dial the receiver's extension in a state 312. Subsequently, the process may proceed to the decision diamond 304. The VAS may receive the extension and send relevant information, such as caller ID, extension, and transaction information, to BAS 112 in states 314 and 316. As discussed in conjunction with FIGS. 2A-2B, the BAS 110 may receive the call from the caller and connect calling party with the called party, forming a voice path. In one exemplary embodiment, the voice path may go through the VAS, as described in the current flow chart 300. In another exemplary embodiment, the voice path may not directly go through the VAS.

In a state 322, the BAS 112 may receive the information from the VAS 110. Then, the BAS may verify that the extension exists in the database 114 and is associated with an internet ID of the receiver (or, internet user) in a state 324. Next, the BAS may send a call notification, via Instant Messenger or email, to the called party's internet ID (or, internet user's ID) in a state 326. Then, the process may proceed to a state 332.

As discussed in conjunction with FIGS. 2A-2B, the BAS 112 may notify the internet user of the incoming call based on an internet communication method used by the called party. The BAS may also hold a database with many different associations. In one exemplary embodiment, the BAS maps an extension number to user's internet ID, multiple internet IDs associated with one extension, or the like.

In the state 332, the receiver or internet user may receive the call notification on his/her internet ID, e.g., via Instant Messenger, email, or the like. Then, in a state 334, the internet user may click on the call notification, which is in the form of a URL in one exemplary embodiment. As the internet user clicks on the call notification, the internet communication software may send the BAS a click notification that the receiver clicked on the notification. The BAS 112 may receive the click notification in a state 328 and launch an IMVocal applet phone on the internet user's internet device, such as PC 118a, in a state 330. In one exemplary embodiment, the applet phone may run on a web browser opened by clicking the URL in the state 334. Then, the process may proceed to a state 336.

The internet phone may include, but not limited to, an applet that runs on the called party's internet device, such as 118a. For brevity, the terms internet phone is used interchangeably with the term phone applet hereinafter. In one exemplary embodiment, the internet phone may be displayed on a web browser of the called party's internet device along with scripts and/or other applets for advertisement, thereby allowing the IMVocal server 108 to generate cost-per-thousand impressions (CPM) based revenue. The internet phone may connect the internet user (or called party) to the incoming call via the network 102.

In the state 336, the IMVocal internet phone may be launched on called party's internet device 118a. Then, in a state 338, the internet phone may use the URL clicked by the internet user in the state 334 to know how to connect the internet user (more specifically, the internet device 118a of the internet user) to the caller. Subsequently, in a state 340, the internet phone may send the call details to the VAS with the call details, wherein the call details include, but is not limited to, the CALLID, Internet-User's ID, or the like. The IMVocal internet phone or phone applet may send at least one identifier that is unique to the incoming call so that the VAS 110 can understand which call the phone applet has be connected to. In one exemplary embodiment, the identifier may be the CALLID. The call details may also contain other optional information that may be useful for the VAS to provide new features.

In a state 318, the VAS may receive the call detail from the phone applet. Then, the VAS may join the calling party and called party, completing a call connection therebetween in a state 320. The call may be disconnected if the available call minutes are zero or either part has disconnected the call.

Once the call is over, the IMVocal server may play a message to the caller, providing an option to listen to local deals. If the caller accepts the option, the IMVocal server 108 may provide, based on information of the caller's location, information (or advertisements) of local shops near the caller, or information of events that the caller may be interested in. By playing the local deals or events information to the caller, the IMVocal server 108 may generate cost-per-lead and call-transfer apart from pay-per-click (PPC) based revenues. If the caller does not accept the option, the IMVocal server may end the call.

It will be appreciated by those of the ordinary skill that the illustrated process in the flow chart 300 may be modified in a variety of ways without departing from the spirit and scope of the present invention. Also, as one of ordinary skill in the programming art can implement without undue experimentation the software program to execute the process steps of FIGS. 2A-3, a detailed description as to the implementation of the software program is not given in the present document.

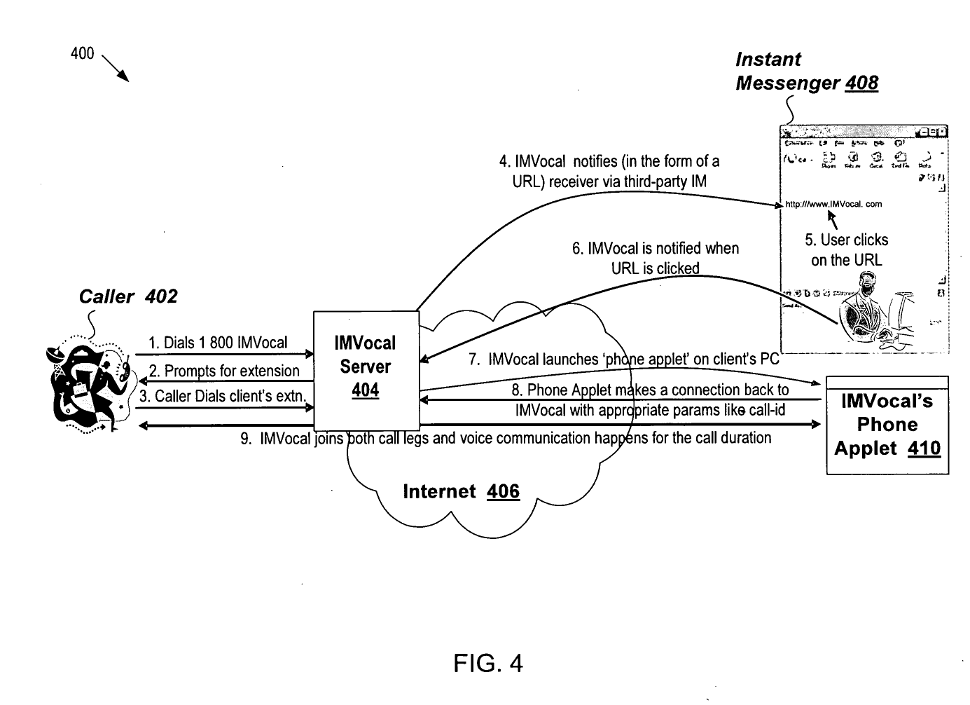

FIG. 4 shows a flow chart 400 illustrating an exemplary process for connecting a phone to an internet user (receiver) in accordance with another embodiment of the present invention. As depicted, a caller 402 may dial an IMVocal number using a communication device (such as one of the phones 104a-104d in FIG. 1) in step 1. Then, the IMVocal server 404 may prompt the caller 402 to enter an extension of a receiver (or a client device used by the receiver) in step 2. Subsequently, the caller 402 may dial the extension in step 3. Then, the process may proceed to step 4.

In step 4, the IMVocal server 404 may notify the receiver of the call via a third-party Instant Messenger 408 that may run on a client device (such as one of the devices 118a-118c), wherein the client device may be connected to and communicate signals with the IMVocal server 404 via the internet 406. In one exemplary embodiment, a URL may be displayed on the Instant Messenger 408. Next, in step 5, the receiver may click on the URL. Subsequently, the IMVocal server 404 may be notified when the URL is clicked in step 6 and launch an IMVocal's phone applet 410 (or, shortly phone applet) on the client device in step 7. In one exemplary embodiment, the phone applet 410 may be included in a web page that is opened by clicking the URL in step 5. Then, in step 8, the phone applet 410 may make a connection back to the IMVocal server 404 with an appropriate parameters, such as CALLID. Next, the IMVocal server 404 may join both call legs so that a communication is established between the caller 402 and receiver in step 9.

While the invention has been described in detail with reference to specific embodiments thereof, it will be apparent to those skilled in the art that various changes and modifications can be made, and equivalents employed, without departing from the scope of the appended claims.

What is claimed is:

1. A method of connecting a phone to a client via a network, comprising:
receiving a call from the phone;
sending a notification of the call to the client;
causing a user of the client, receiver, to launch an internet phone on the client in response to the notification; and
connecting the phone to the client via the internet phone whereby providing a communication between the receiver and a user of the phone, caller.

2. The method of claim 1, wherein the step of receiving a call includes:
receiving a phone number from the phone;
prompting the caller to enter an extension of the receiver; and
receiving the extension from the phone.

3. The method of claim 2, wherein the extension expires upon lapse of a preset period of time from issuance thereof.

4. The method of claim 1, wherein the step of receiving a call includes:
playing a commercial message to the caller.

5. The method of claim 1, wherein the step of receiving a call further includes:
assigning an identifier to the call.

6. The method of claim 1, further comprising, prior to the step of sending a notification:
looking up a database to check whether the client associated with the extension exists in the database; and
if the client does not exist in the database,
ending the call; and
otherwise,
performing the step of sending a notification.

7. The method of claim 1, wherein the client includes an online service and wherein the step of sending a notification includes sending an applet URL having an URL address to the online service.

8. The method of claim 7, wherein the step of causing a receiver to launch an internet phone includes:
causing the receiver to click on the applet URL so that a web browser is opened on the client,
wherein the internet phone is an applet and included in the web browser.

9. The method of claim 7, wherein the step of causing a receiver to launch an internet phone includes:
causing the receiver to open a web browser on the client and to enter the URL address in the web browser,
wherein the internet phone is an applet and included in the web browser.

10. The method of claim 1, wherein the client includes an email service and wherein the step of sending a notification includes sending an email to the email service and wherein the email includes an URL address to launch the internet phone.

11. The method of claim 10, wherein the step of causing a receiver to launch an internet phone includes:
causing the receiver to open a web browser on the client and to enter the URL address in the web browser,
wherein the internet phone is an applet and included in the web browser.

12. The method of claim 1, further comprising, prior to the step of causing a receiver to launch an internet phone:
putting the caller on hold; and
playing a ringtone to the caller.

13. The method of claim 12, wherein the ringtone includes a commercial message.

14. The method of claim 1, further comprising, prior to the step of causing a receiver to launch an internet phone:
checking whether the caller is a denial-of-service (DOS) attacker; and
if the caller is a DOS caller,
ending the call, and
otherwise,
performing the step of causing a receiver to launch an internet phone.

15. The method of claim 1, wherein the internet phone is an applet to be included in a web browser displayed on the client.

16. The method of claim 15, wherein the web browser displays one or more advertisement.

17. The method of claim 16, further comprising, after the step of the connecting the phone to the client:
disconnecting the phone from the client;
providing to the caller an option to listen to local deals; and
if the caller accepts the option,
playing information of the local deals; and
otherwise,
ending the call.

18. The method of claim 1, wherein the network is the Internet.

19. A system for connecting a phone to a client via a network, comprising:
a server connected to the network and including:
means for receiving a call from the phone;
means for sending a notification of the call to the client;
means for causing a user of the client, receiver, to launch an internet phone on the client in response to the notification thereby to accept the call; and
means for connecting the phone to the client via the internet phone whereby providing a communication between the receiver and a user of the phone, caller.

20. The system claim 19, wherein the server further includes:
means for receiving a phone number from the phone;
means for prompting the caller to enter an extension of the receiver; and
means for receiving the extension from the phone.

21. The system of claim 19, wherein the client includes an online service and wherein the server includes:
means for sending an applet URL having an URL address to the online service.

22. The system of claim 21, wherein the server includes:
means for causing the receiver to click on the applet URL thereby to open a web browser on the client,
wherein the internet phone is an applet and included in the web browser.

23. The system of claim 21, wherein the online service includes a list of contacts, said list including a bot corresponding to the server.
